(19) United States
(12) Patent Application Publication
(10) Pub. No.: US 2002/0093819 A1
(43) Pub. Date: Jul. 18, 2002

(54) Rapidly directional assembled and water-proof lamp

(76) Inventors: Ching-Sheng Chen, Taipei City (TW); Chun-Teng Lee, Taipei City (TW); Chu-Cheng Chang, Taipei City (TW)

Correspondence Address: CHING-SHENG CHEN, P.O. BOX 7-820, TAIPEI, R.O.C., TW

(21) Appl. No.: 09/761,796

(22) Filed: Jan. 18, 2001

(51) Int. Cl. F21V 29/00

(52) U.S. Cl. 362/226; 362/267; 362/249

(57) ABSTRACT

A rapidly directional assembled and water-proof lamp comprises a bulb, a washer, and a seat. The bulb has a casing connected to a flat engaging portion, and each surface of the flat engaging portion is installed with a trench and a longitudinal groove. A flat groove is formed in the seat with two opposite outer walls. Each wall has a transverse block and a longitudinal strip at position with respect to the trench and longitudinal groove of the flat groove. Thereby, the bulb is directionally engaged with the seat; and a front opening of the flat groove has a toggle. An annular flange is formed below the toggle so that the bulb and seat are engaged. The annular flange and the toggle buckle a cambered portion of the bulb; and thus, by the elastic force of the annular flange and the washer, water will not permeate into the bulb to induce a short circuit. Therefore, a bulb with functions of rapidly directional assembly and water-proof is formed.

### BACKGROUND OF THE INVENTION

1. Field of the Invention

The present invention relates to a rapidly directional assembled and water-proof lamp comprising a bulb, a washer, and a seat. Thereby, a bulb with functions of rapidly directional assembly and water-proof is formed.

2. Description of he Prior Art

Currently, in assembly of a lamp, a seat is placed at the top of a bulb having a copper cap. The male thread of the cap is engaged with a female thread of the seat groove. Since the neck portion of the bulb has a round shape, the copper cap is used as an interface in engagement. However, the copper cap is expensive and much working time is required. Furthermore, many circles of threads are necessary in engaging, while this process needs many working time and thus cost is high. The yield ratio is thus low. Moreover, the copper cap can is water-proofed, and thus it is possible that the bulb is short-circuited due to permeation of water.

### SUMMARY OF THE INVENTION

Accordingly, the primary object of the present invention is to provide a rapidly directional assembled and water-proof lamp comprising a bulb, a washer, and a seat. Thereby, a bulb with functions of rapidly directional assembly and water-proof is formed.

Another object of the present invention is to provide a rapidly directional assembled and water-proof lamp, wherein the bulb has a casing connected to a flat engaging portion, and each surface of the flat engaging portion is installed with a trench and a longitudinal groove. A flat groove is formed in the seat with two opposite outer walls. Each wall has a transverse block and a longitudinal strip at position with respect to the trench and longitudinal groove of the flat groove. Thereby, the bulb is directionally engaged with the seat; and a front opening of the flat groove has a toggle.

A further object of the present invention is to provide a rapidly directional assembled and water-proof lamp, wherein an annular flange is formed below the toggle so that the bulb and seat are engaged. Thus, the annular flange and the toggle buckle a cambered portion of the bulb.

A yet object of the present invention is to provide a rapidly directional assembled and water-proof lamp, wherein by the elastic force of the annular flange and the washer, water will not permeate into the bulb to induce a short circuit.

The various objects and advantages of the present invention will be more readily understood from the following detailed description when reading in conjunction with the appended drawing.

### BRIEF DESCRIPTION OF THE DRAWINGS

FIG. 1 is a perspective view of the rapidly directional assembled water-proof lamp according to the present invention,

FIG. 2 shows the components of the present invention.

FIG. 3 shows the structures of the bulb and seat in the present invention.

FIG. 4 illustrates that the bulb is engaged with the seat of the present invention.

FIG. 5 shows that a bulb is buckled by the annular flange and washer according to the present invention.

### DELTAILED DESCRIPTION OF THE PREFERRED EMBODIMENT

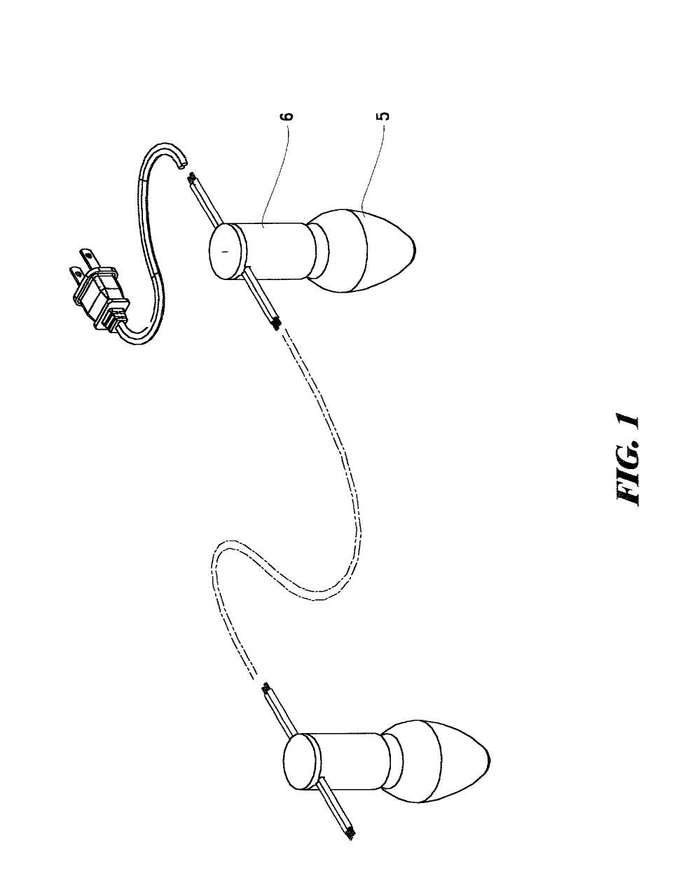

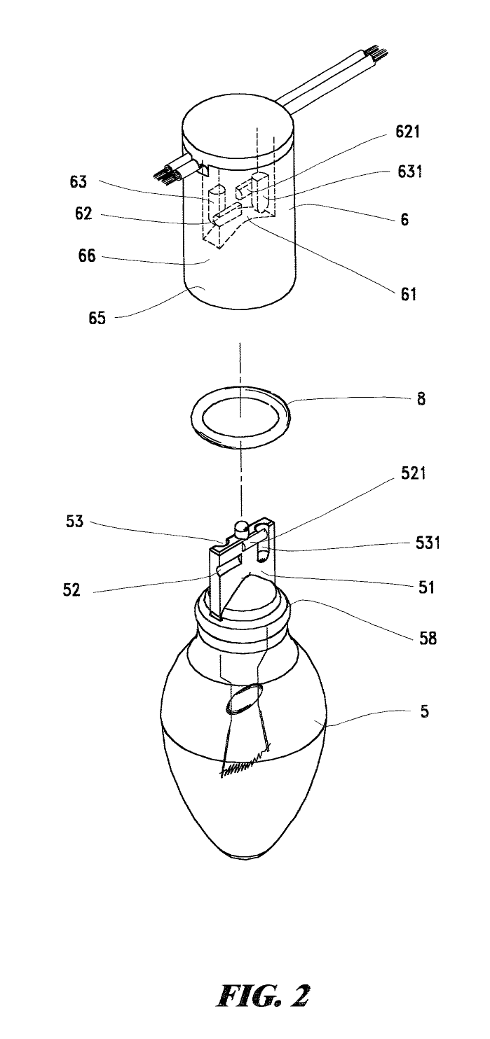

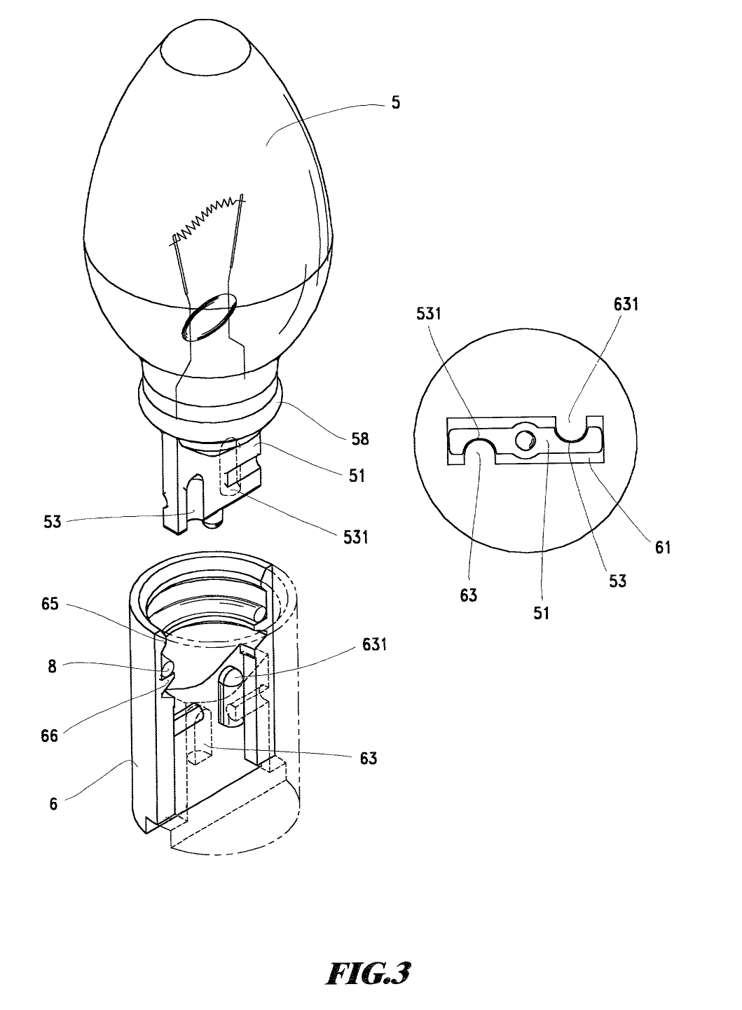

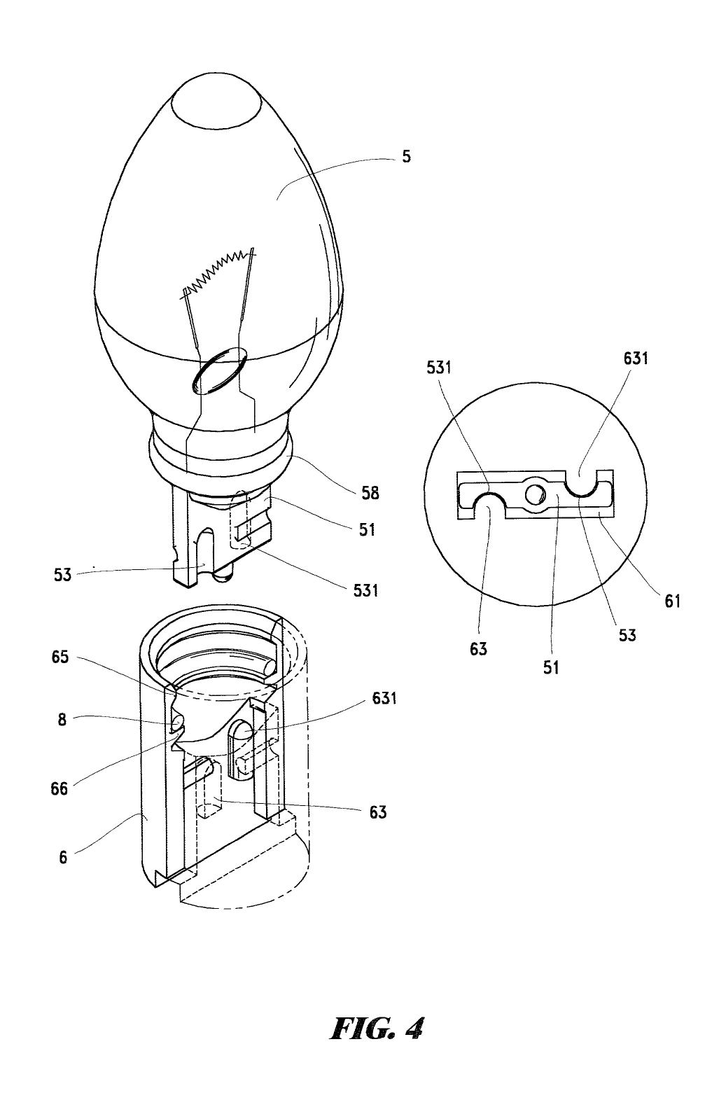

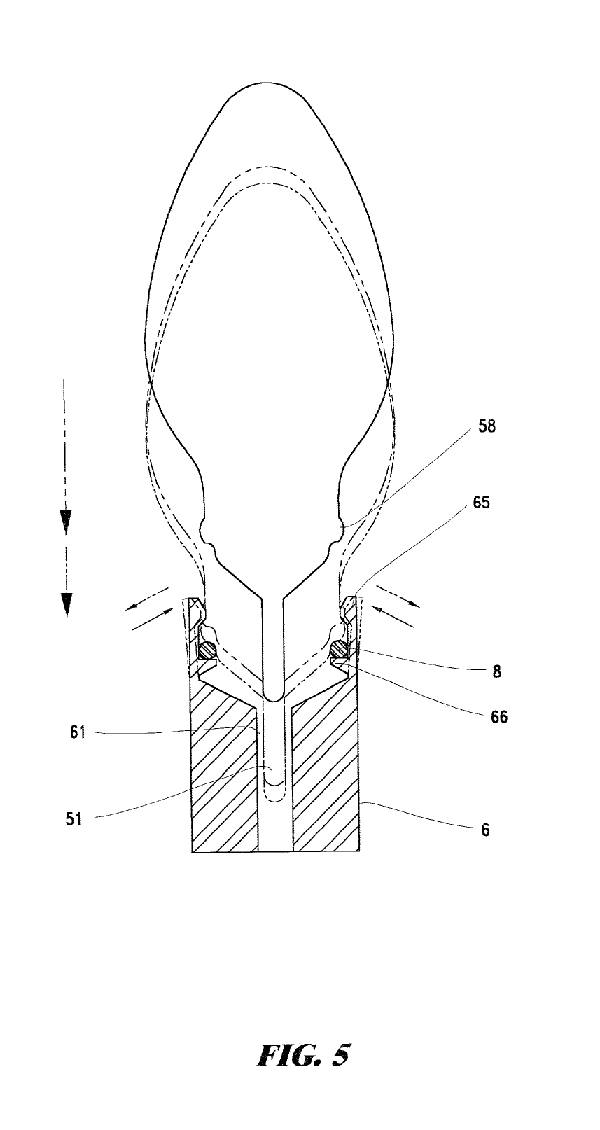

With reference to FIGS. 1 to 5, the rapidly directional assembled water-proof lamp of the present invention is illustrated. The rapidly directional assembled water-proof lamp of the present invention is formed by a bulb, a washer, and a seat. The bulb has a casing, which is connected to a flat engaging portion 51. Two surfaces thereof are installed with trenches 52 and 521, and longitudinal grooves 53 and 531. A flat groove 61 is formed in the seat 6. Two transverse blocks 62 and 621 and two longitudinal strips 63 and 631 are formed on the walls of the flat groove. Thereby, the bulb is directionally engaged with the seat. A front opening of the flat groove 61 has a toggle 65. An annular flange 66 is formed below the toggle so that as the bulb and seat are engaged, the annular flange 66 and the toggle 65 can buckle a cambered portion 58 of the bulb. Thus, by the elastic force of the annular flange and the washer, water will not permeate into the bulb to induce a short circuit. Therefore, a bulb with functions of rapidly directional assembly and water-proof is formed.

The above described embodiments are not intended to limit the scope of the present invention, as one skilled in the art can, in view of the present invention, expand such embodiments to correspond with the subject matter of the present invention claimed below. Therefore, all such substitutions and modifications are intended to be embraced within the scope of the invention as defined in the appended claims.

I claim:

1. A rapidly directional assembled and water-proof lamp comprising a bulb, a washer, and a seat, wherein
the bulb has a casing, the casing is connected to a flat engaging portion; and each surface of the flat engaging portion is installed with a trench and a longitudinal groove;
a flat groove is formed in the seat with two opposite outer walls; each wall has a transverse block and a longitudinal strip at position with respect to the trench and longitudinal groove of the flat groove; thereby, the bulb is directionally engaged with the seat; and
a front opening of the flat groove has a toggle; an annular flange is formed below the toggle so that the bulb and seat are engaged; the annular flange and the toggle buckle a cambered portion of the bulb; and thus, by the elastic force of the annular flange and the washer, water will not permeate into the bulb to induce a short circuit; therefore, a bulb with functions of rapidly directional assembly and water-proof is formed.
